(19) United States
(12) Patent Application Publication
(10) Pub. No.: US 2025/0343981 A1
(43) Pub. Date: Nov. 6, 2025

(54) SYSTEMS AND METHODS FOR TRANSMITTING VIDEO SCENE INFORMATION

(71) Applicant: Comcast Cable Communications, LLC, Philadelphia, PA (US)

(72) Inventor: Robert Smith, Boulder, CO (US)

(21) Appl. No.: 18/653,192

(22) Filed: May 2, 2024

(51) Int. Cl. H04N 21/854; H04N 21/81; H04N 21/845

(52) U.S. Cl. CPC H04N 21/854; H04N 21/812; H04N 21/814; H04N 21/8456

(57) ABSTRACT

Systems, apparatuses, and methods are described for generating supplemental data that may be contemporaneous with audio or video content and that may be shared with, and used by, a player and connected devices. To overcome limitations on computing power and the need for external hardware at the player, encryption of the audio or video content may be performed subsequent to the generation of the supplemental data and over the entire duration of the content. The encrypted content along with the supplemental data may be provided, in a packaged content file, to the player to enhance the experience of a user of the content.

### BACKGROUND

Individuals watching content like a television show and/or a movie may experience audio and visual immersion associated with the content. The device controlling the playback of the content may be equipped to communicate with other devices that may be configured to provide information to enhance the entertainment environment and experience for the individuals watching the content. Providing and processing such information can be challenging for devices, such as video players, that use computing resources on other tasks. These shortcomings are identified and addressed by the disclosure.

### SUMMARY

The following summary presents a simplified summary of certain features. The summary is not an extensive overview and is not intended to identify key or critical elements.

Systems, apparatuses, and methods are described for generating supplemental data to enhance the video consumption environment and experience. Such supplemental data can comprise timed metadata that may include a mood and/or theme characterization, color analysis, and other variables over the entire time, or duration of a piece of content. Supplemental data can be provided to homes and video players in various ways. Display devices may connect to local area networks (LAN) and may communicate directly with other devices that are connected to the LAN or may communicate indirectly through a cloud service. Many of these devices may generate effects that our senses may experience. Lighting systems may generate ambient lighting that may enhance the mood of a scene. Scent technology may generate ambient smells to provide a sensation of the environment presented in the content. Haptic technology may generate vibrations to generate a feeling of motion and/or action. Individuals watching content on a display device may experience immersion beyond the visual and audio content by including ancillary devices that may enhance the experience of viewing content by changing ambient lighting, shaking a seat, and/or releasing aromas at specific times during playback of the content. Limitations imposed by limited processing power of devices and encryption may be overcome, for example, by performing analysis of the video and creating the supplemental data, at a server, at a time prior to encryption being applied. A manifest containing the metadata may be generated, for example, that coordinates the video with the metadata and may be used to control other devices that are connected to the LAN.

These and other features and advantages are described in greater detail below.

### BRIEF DESCRIPTION OF THE DRAWINGS

Some features are shown by way of example, and not by limitation, in the accompanying drawings In the drawings, like numerals reference similar elements.

FIG. 1 shows an example communication network.

FIG. 2 shows hardware elements of a computing device.

FIG. 3 shows an example of an entertainment environment.

FIG. 4 shows an example method for receiving content and generating supplemental data of the content before encryption of the content.

FIG. 5 shows an example of a supplemental data table.

FIG. 6 shows an example of a player receiving content data, a manifest, and supplemental data to control an entertainment environment.

FIGS. 7A and 7B show examples of device controlling players.

FIG. 8 shows an example of a user profile data file.

FIG. 9 shows an example method of a player receiving a packaged content and supplemental data file.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

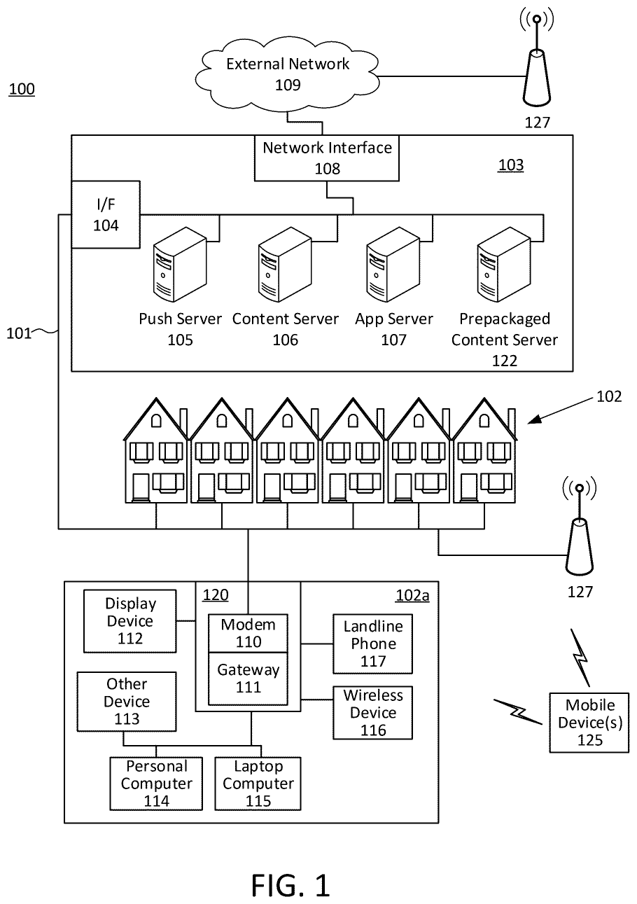

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as the prepackaged content server 122 (described below), additional push, content, and/or application servers, and/or other types of servers. Although shown separately, the push server 105, the content server 106, the application server 107, the prepackaged content server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), mixed reality (MR) and augmented reality (AR) headsets, and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

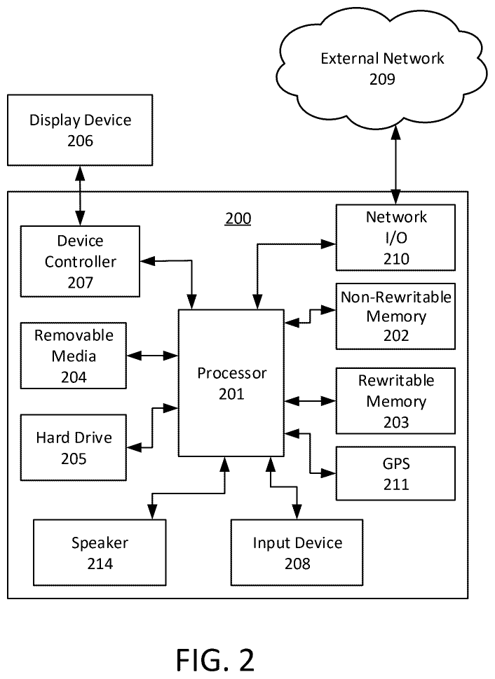

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a player, a phone, a table, a computer, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

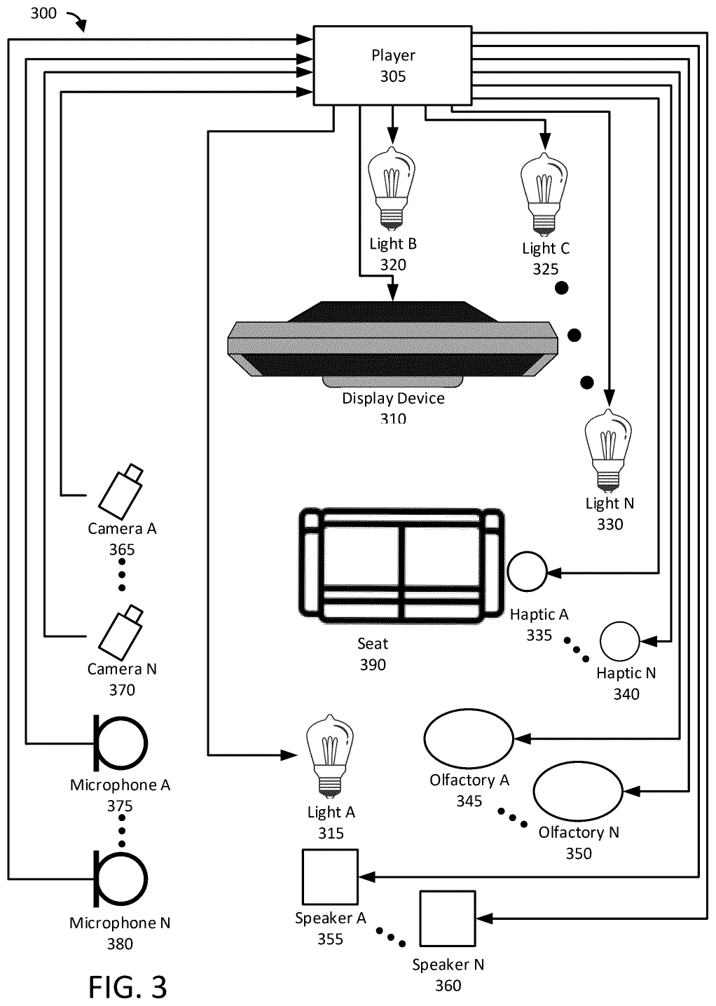

FIG. 3 shows an example of an entertainment environment. As shown in FIG. 3, entertainment environment 300 includes an area where one or more people may be entertained by content displayed on a display device 310. In some embodiments, entertainment environment 300 may comprise a movie theater that may entertain hundreds of people, or an entertainment environment 300 may comprise a home theater that may entertain a single person, an entire family, and/or dozens of people in a group. The example in FIG. 3 depicts entertainment environment 300 that includes a player 305 and a display device 310. An entertainment environment 300 may also comprise one or more seats 390 and/or one or more ancillary devices (e.g., input devices and/or output devices). A player may communicate with one or more control devices (e.g., a set top box, a phone, a tablet, a computer, etc.) to receive a user's request for content.

A player 305 may comprise software components (not shown) running on hardware (e.g., a set top box, a computer, etc.). Some components of a player 305 may not be shown. Rather, components that may be involved in using supplemental data (e.g., timed metadata) to enhance a user's experience (e.g., via control of output devices and/or interaction with ad decisioning) are shown.

A player 305 may communicate with input devices and/or output devices that are external to the player 305 and/or are configured within a housing of the player 305, according to various embodiments. In addition, player 305 may communicate with one or more input devices. An input and/or output device may communicate with the player 305 via a wired connection and/or wirelessly. An input device may aid in customizing a user's experience with content from a player 305. An input device may gather information about an entertainment environment 300 for the player 305 and/or for data analysis. Input devices may comprise cameras, microphones, and/or personal devices (e.g., phones, tablets, computers, wearables, etc.).

One or more cameras (e.g., camera A 365, camera N 370, etc.) may be used to measure lighting levels, to locate users, and/or to locate items in an entertainment environment 300. A camera may measure ambient light in a room, for example, to determine how bright and/or what color settings to use to illuminate bias lighting of a display device 310. A camera may determine the location of a user and/or if a user moves. A player 305 may increase the lighting levels and/or change the color scheme around a user making it easier for the user to see, for example, if a camera determines that a user is moving in the entertainment environment 300. A camera (e.g., camera A 365) may determine that certain individuals prefer a brighter ambient lighting. A player 305 may raise ambient lighting levels, for example, if the player 305 receives data from camera A 365 indicating that a younger viewer that prefers a brighter entertainment environment 300 is in the entertainment environment 300. These preferences may be changed and/or overridden using settings and/or override commands.

One or more microphones (e.g., microphone A 375, microphone N, 380, etc.) may measure ambient sounds and/or ambient sound levels. A player 305 may change ambient lighting, color schemes, volume levels, and/or to tailor other device controls to a user's preferences, for example, if the player 305 determines from data received from a microphone (e.g., microphone A 375) that a particular user is in the entertainment environment 300 and the player 305 is configured to provide automatic user preference changes. A microphone (e.g., microphone A 375, microphone N 380, etc.) may measure white noise from outside of the entertainment environment 300. A player 305 may use a speaker (e.g., speaker A 355, speaker N 360, etc.) to provide noise cancelling sounds to minimize white noise, for example, based on the white noise measured by a microphone (e.g., microphone A 375, microphone N 380, etc.). A microphone (e.g., microphone A 375) may measure sound levels within the entertainment environment 300. A player 305 may change output sound levels to speakers (e.g., speaker A 355, speaker N 360, etc.), for example, if the player 305 determines that sound levels exceed a threshold value based on data received from the microphone 375 (e.g., microphone A). A player 305 may, also, change output sound levels to speakers (e.g., speaker A 355, speaker N 360, etc.), for example, if the player determines that the output of the speakers (e.g., speaker A 355, speaker N 360, etc.) are not balanced based on sound measurements received from the microphones (e.g., microphone A 375, microphone N 380, etc.).

Some embodiments may include additional ancillary input devices may include force sensors, motion sensors, personal devices (e.g., phones, tablets, computers, wearables, etc.), and/or other devices that may connect to a player 305 and/or an internet of things (IoT) server. A player 305 may determine where users may be seated, for example, based on a force sensor in a seat 390 measuring an increased force. A player 305 may adjust output sounds to speakers (e.g., speaker A 355, speaker N 360, etc.), for example, based on the location of people within an entertainment environment 300. A player 305 may automatically stop playing the content and/or increase ambient lighting levels, for example, based on receiving an indication that a visitor is at the front door from a IoT enabled door bell or front door motion sensor, and/or based on receiving an indication from a phone that an important call is incoming.

A player 305 may, also, communicate with one or more output devices. An output device may be external to the player 305 and may receive control commands from the player 305 (e.g., to enhance the audio and visual (A/V) experience) via a wired and/or wireless connection. An output device may be configured in a housing of the player 305. Output devices may comprise one or more speakers (e.g., speaker A 355, speaker N 360, etc.), one or more lighting devices (e.g., light A 315, light B 320, light C 325, light N 330, etc.), one or more haptic devices (e.g., haptic A 335, haptic N 340, etc.), one or more olfactory devices (olfactory A 345, olfactory B 350, etc.), and/or a display device 310.

A display device 310 displays images and/or video content. A display device 310 may comprise settings that may control brightness levels, color schemes, contrast, backlighting, etc. A player 305 may control the settings of a display device 310. The player 305 may determine, for example, that a particular user is watching the content and the player 305 may change output settings to a display device, for example, based on a determination of a user and a user's preferred display device settings. The player may turn on close captioning, for example, based on the player determining that the user preference includes closed captioning. Also, or alternatively, the player may connect to a user's ear phones, for example, based on determining that the user prefers receiving audio content using ear phones. A user may have trouble hearing conversations over background noises, for example, if the user has some level of hearing loss. The player may provide different levels of sound in different channels. The player may provide conversations to a user's ear phones, for example, if the user indicates that they would like to receive conversations at a higher volume and/or directed to the ear phones. The player may increase the volume of channels carrying conversations of content, for example, if settings indicate a conversation volume is greater that other sound sources.

Output devices of a player may be configured and used to enhance a user's experience. Output devices may provide a mood, convey a theme, and/or signal an upcoming event. Output devices may comprise lighting devices (e.g., light A 315, light B 320, light C 325, light N 330, etc.). Output devices may also comprise extended reality (XR), including augmented reality (AR) or mixed reality (MR), headsets that may combine pass through images of the device's surroundings with computer generated effects (e.g., lighting effects).

A housing of a display device 310 may comprise one or more background lighting devices that may be configured into the housing of the display device 310. The background lighting devices may provide lighting that enhances the content on the display device 310. The lighting provided by a background lighting device may produce bright blue lighting, for example, if the scene is an outdoor scene with a clear blue sky. The lighting provided by a background lighting device may produce a dark reddish orange background, for example, if the scene is a sunset. The lighting provided by a background lighting device may produce periodic flashes of lights of different colors, for example, if the theme is a pitched space battle. An AR or MR headset may allow a user to view what is on the display device 310, for example, but with additional generated effects (e.g., a color hue, a space battle spilling out of the display device and into an entertainment environment 300, or flashing lights in peripheral vision).

Also, or alternatively, background lighting devices may not be configured into a housing of a display device 310. Background lighting (e.g., light B 320), rather, may be external to the housing of the display device 310. A display device may comprise one or more lighting devices (e.g., light A 315, light B 320, light C 325, light N 330, etc.) as background lighting devices. A display device 310 may comprise a plurality of lighting devices (e.g., light B 320, light C 325, light N 330, etc.), for example, if the display device is large, and/or if a more nuanced lighting scheme is sought using a finer granularity in background lighting. A display device 310 may have one color scheme on one side of the display device 310 and another color scheme on another side of the display device 310, for example, if the display device is configured with multiple channels of background lights.

Lighting devices other than a display device 310 background lighting may be controlled by a player 305. Lighting devices may comprise one or more sets of ambient lights (e.g., light A 315, light N 330, etc.). A first set of ambient lights (e.g., light A 315), for example, may provide dim lighting in a red hue to allow people to see in entertainment environment 300 without washing out the content shown on the display device 310. A second set of ambient lights (e.g., light N 330), for example, may provide brighter lighting to allow people to see more clearly before or after the content is played and/or during an intermission of the content. Other ambient lighting may turn on, for example, if a camera (e.g., camera A 365) detects a user moving around. The lighting may direct the user out of the entertainment environment 330, for example, if the player 305 determines a user is exiting the entertainment environment 330.

A player 305 may communicate and/or control other output devices (e.g., haptic devices, olfactory devices, etc.). A haptic device (e.g., haptic A 335, haptic N 340, etc.) provides touch sensation through the application of force, vibrations, and/or motion. A player 305 may provide a haptic signal on a wearable device, for example, to indicate an important scene is near. A player may provide a haptic signal to a haptic device 335 (e.g., haptic A) configured in a seat 390. The haptic signal may cause the seat 390 to vibrate, for example, to provide the sensation of train passing or a dinosaur approaching.

An olfactory device (e.g., olfactory A 345, olfactory N 350, etc.) may provide different scents upon receiving a command from a player 305. An olfactory device may introduce a scent of wet grass, for example, if the scene on a display device 310 comprises a spring rain and/or a ball game after a shower. An olfactory device may introduce the scent of a fire, for example, if the scene on a display device 310 comprises a campfire and/or an inferno. Also, or alternatively, an olfactory device may provide a background scent based on user preferences. An olfactory device may introduce the scent of a bouquet of flowers, for example, if the player determines a particular user is in the entertainment environment 300 and that that particular user has set the scent of a flower-field as their background preferred scent.

A hardware package for a player 305 and/or a display device 310 may be configured to comprise one or more input devices and/or one or more output devices. A display device 310 may have integrated bias lighting, for example, on the back of a display device 310. A player 305 may have one or more integrated camera, for example, to monitor lighting levels and/or users. External devices may be automatically discoverable via a centralized internet of things (IoT) hub and/or via a service discovery protocol such as Bonjour. A user may configure a player 305 and/or an IoT service the preferred settings (e.g. minimum brightness) to use for the devices that may be present and/or connected (e.g., discovered), and/or discovered devices that may participate in the supplemental data (e.g., timed metadata) experience enhancement, and/or the role the devices should play (e.g. ambient room lights vs bias lighting). Input and/or output devices may be accessible via a local area network (LAN) and/or wide area network (WAN). A WAN control may be, for example, an If Then Then That (IFTTT) service. All device inputs, all user preferences, and/or all configurations may be shown as “summed” together, for example, so that this information is available to the other player components.

Detecting and analyzing A/V queues necessary to determine supplemental data (e.g., timed metadata) needed to control other devices that enhance an A/V experience from a video file, however, may be fraught with limitations. Detection and analysis of an A/V queue at a player, for example, may require external hardware and/or real-time computational power that may be used for other tasks. Moreover, encryption (e.g., digital rights management (DRM)) may limit the time frame that the A/V signal may be detected and analyzed. By analyzing the video before encryption, and at a place different from a player, for example, the limitations of detecting A/V queues at the player may be overcome and the supplemental data necessary to enhance the A/V experience may be generated over the entire time of the video file.

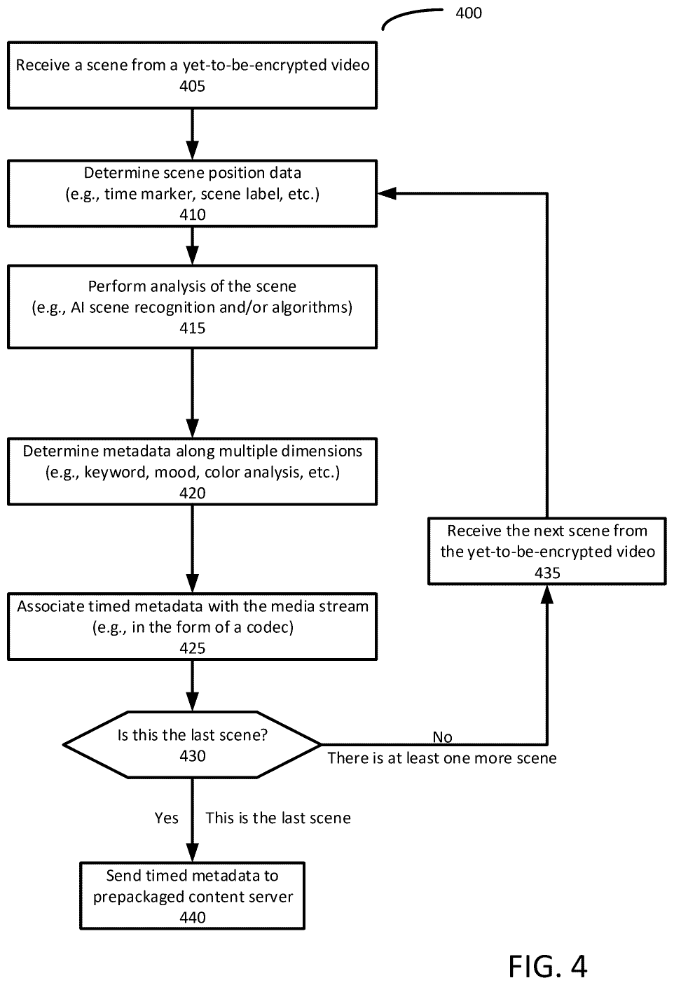

FIG. 4 shows an example method for receiving content and generating supplemental data of the content before encryption (e.g., DRM) of the content. Specifically, FIG. 4 shows an example method 400 for receiving content (e.g., a video file) and generating supplemental data (e.g., timed metadata) of the content. A computing device, at step 405, may receive content (e.g., a video file), for example, that may be encrypted at a later time.

At step 410 the content may be analyzed to determine content position data 410 (e.g., scene position data of a video file). The content position data may comprise, for example, a time marker, a content position label (e.g., a scene label), and/or a content duration. The content may comprise metadata including a time signature that may be used for the position data. Also, or alternatively, a time marker may be determined based on amount of time from the beginning of the content, or a beginning of a portion of the content.

At step 415 the content may be analyzed for content information. A scene of a video file, for example, may be analyzed to determine supplemental data (e.g., timed metadata) associated with the scene. The supplemental data that may be determined may be associated with the position data determined in step 410. Artificial intelligence (AI) may be used to recognize scene details. AI may be used, for example, to recognize objects, characters, actors, locations, times of day, etc. Additionally, other algorithms and/or methods may be used to analyze the scene of a video. Machine learning may be trained, for example, to recognize a police chase, to recognize a forest, and/or to determine more important characters on the video. Audio of video file may also be analyzed to determine scene details. A change in music may indicate a change in scene theme. The characters in the video may explain their situation and/or their current moods.

At step 420 supplemental data (e.g., timed metadata) may be determined and/or generated based on the analysis of the content in step 415. Supplemental data may comprise keywords associated with the content. A video file may have keywords comprising a location, a time of day, weather, season, and/or event. Keywords associated with a video file may comprise city, cold, sunset, sporting event, for example, if a video file shows a police chase through a city during winter and ending at a sporting event as the sun sets. Other dimensions to the content may be determined. Other dimensions may comprise, for example, a mood (e.g., sad, violent, scared, etc.) and/or color analysis (e.g., dominant hue, saturation, value palettes, and/or palette by video quadrant) of a video file. The listed dimensions are only meant as examples and do not form a complete set.

At step 425 the supplemental data (e.g., the timed metadata) may be associated with the content (e.g., a video file) media stream. The association may be through a code/decode (codec) process. The time association may comprise timed queues tagged with supplemental data changes. The files encoding the supplemental data may be included in a media manifest (e.g., dynamic adaptive streaming over hypertext transfer protocol (HTTP) media presentation description (DASH MPD) or HTTP live streaming (HLS) m3u8).

The entire duration of the content may be analyzed per steps 405 through 425, for example, by generating the supplemental data for each portion of the content and appending supplemental data of portions of the content at later times to the supplemental data of the portions of the content that occur earlier in time. At step 430, for example, it may be determined if additional portions of the content may be analyzed. It may be determined at step 430, for example, if the scene of a video file just analyzed is the last scene of the video file. The next scene may be received at step 435, for example, if, at step 430, it was determined there are additional scenes of the video file. Alternatively, analysis of the video file may end, for example, if, at step 430, it was determined there are no additional scenes of the video file.

The supplemental data (e.g., the timed metadata) may be stored on a server (e.g., a prepackaged content server 122). The supplemental data may be sent, for example, to the server at step 440. The supplemental data may be stored and retrieved at a later time, for example, if a user requests the particular content associated with the supplemental data. Future analysis (e.g., method 400) of content may not need to be performed, for example, if the supplemental data is available for retrieval. For some content, the content and its supplemental data may be prepackaged and stored.

A player may send a request, to a server (e.g., a prepackaged content server 122), for content. The server may determine, for example, if the content is prepackaged or not. The player may receive a packaged content file including the content (e.g., a video file) and supplemental data (e.g., timed metadata) of the content from the server, for example, if the supplemental data exists on the server. Alternatively, the server may cause the content to be analyzed and supplemental data be determined (e.g., as described herein in FIG. 4), and/or the content and supplemental data to be packaged, for example, if the prepackaged content server determines that the supplemental data does not exist on the server. The supplemental data may include a manifest. The player may extract the supplemental data from the manifest and load the supplemental data file(s). The player may compare the timing from the content being played and the supplemental data to enhance the viewing experience by controlling other devices (e.g., bias lights that illuminate a wall behind a viewing device).

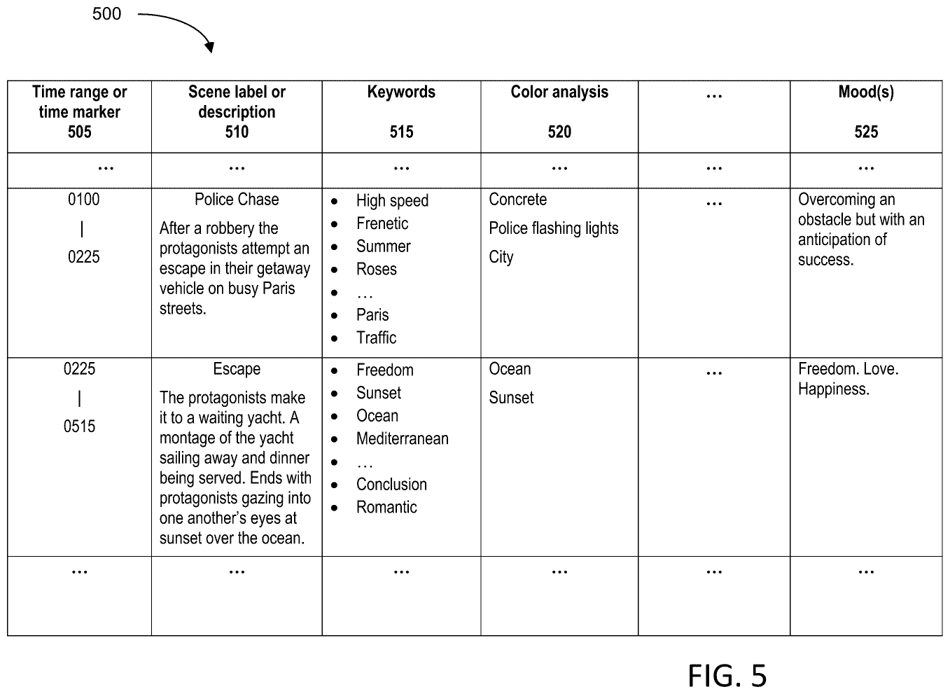

FIG. 5 shows an example of a supplemental data table. Specifically, FIG. 5 shows an example of supplemental data (e.g., timed metadata) table 500 of a video file comprising a police chase and an escape. Supplemental data 500 may comprise, for example, one or more pieces of data comprising a time and/or a time range 505, a scene label and/or description 510, one or more keywords 515, a color analysis 520, mood(s) 525, etc. The time and/or time range 505 of supplemental data 500 may be indexed with a video. The time and/or time range 505 may be indexed to the video based on a common time stamp. The time and/or time range 505 may be indexed to a start of a scene of the video.

A scene label or description 510 may comprise a title of a scene and/or an overview of the scene. The scene label or description 510 may provide additional data that may be used in supplemental data (e.g., timed metadata) analysis. A scene label may be based on scene labels associated with the content. Comparing the time and/or time range 505 corresponding to a scene label or description 510 of the supplemental data to a scene label and/or time range of A/V sections may allow a player to track time and/or adjust for a misalignment in time.

Keywords 515 may comprise a list of words associated with a scene. The keywords 515 may comprise a list of words that a player may use to control scenes. The keywords may, for example, cause a change a scent an olfactory device produces. A player may provide a scent of roses, for example, if the keywords include the word rose. A player may provide a scent of an ocean, for example, if the keyword includes the word ocean. Keywords 515 may be based on a scene label or description 510. Ocean may be in keywords 515, for example, if a scene label or description 510 includes ocean.

Color analysis 520 may comprise data of a color palate of a scene. The color palate may be based on analyzing the color of a number of pixels of content that may displayed on a display device. The color palate may be used by a device to control a background color of a display device. The background color may be different for different parts of the display device. The color palate of a scene may comprise a theme characterization palette. A theme characterization palette may provide background color schemes based on the scene. The background color of a display device may comprise an orange color on the top and a dark blue color on the bottom of the display, for example, if the scene includes a sunset over an ocean. The background lighting may darken and/or flash red and/or blue, for example, during a dark police chase scene.

Mood 525 and/or theme data may comprise a list of words that may provide details of the scene. A scene of a heroes heading into the sunset may comprise themes of freedom and/or happiness. A player may interpret the mood 525 and/or theme to cause ambient lighting to change depending on the mood and/or theme. A player may dim background lighting and/or darken the background lighting, for example, if the mood is dark and/or the theme is loss. A player may warm the background lighting and/or change a color tone to brighter tones, for example, if the mood is happiness and/or the theme is freedom. A player may anticipate a change in moods based on supplemental data (e.g., timed metadata) 500. The player may have the background lights in a dark and/or dim mode, for example, if the scene is dark and foreboding. The player may determine that the mood 525 and/or theme of the video may change in the next scene. The player may blend the dark and/or dim mood with a brighter and/or warmer mood and gradually decrease the weight of the dark mood to the brighter mood as the former scene ends and the new scene begins.

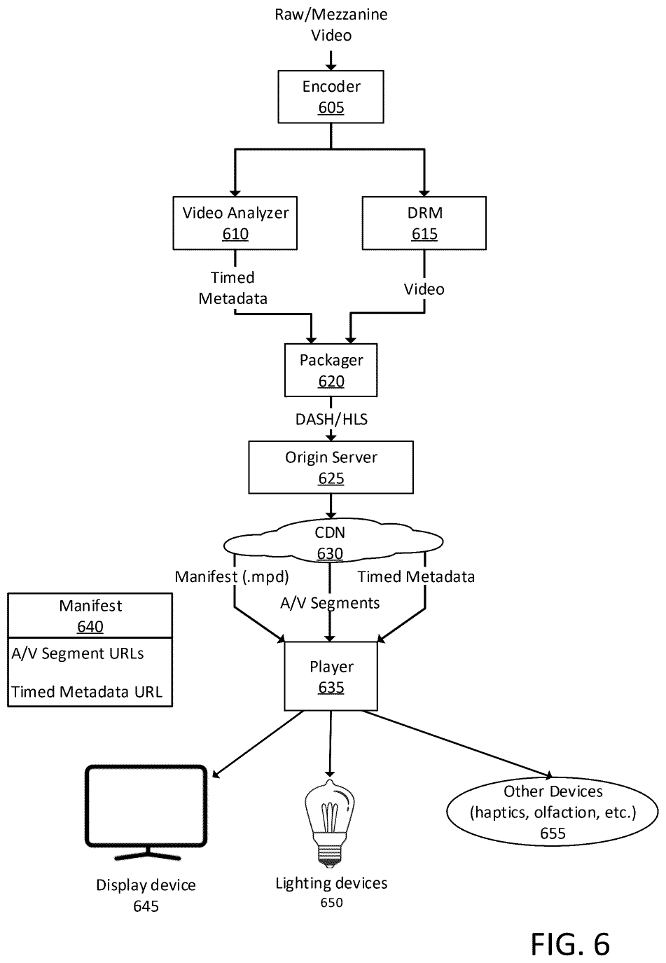

FIG. 6 shows an example of a player receiving content data, a manifest, and supplemental data (e.g., timed metadata) to control an entertainment environment. Specifically, FIG. 6 shows an example of a player (e.g., player 635) receiving audio and video (A/V) data and supplemental data (e.g., timed metadata) for display of the A/V data on a display device and control of ancillary devices using the supplemental data. An encoder 605 may provide feeds of raw or mezzanine video to a video analyzer 610 and/or a digital rights management (DRM) 615 system. The DRM 615 provides for the necessary protections to prevent digital content from being stolen. The DRM 615 system sends video to a packager 620. The video analyzer 610 may rely on artificial intelligence (AI), big data analytics, machine learning, and/or neuro networks, for example, to recognize objects, places, actors, actions, moods, themes, etc. of streaming video and extract metadata at video, shot, scene, and/or frame level. The video analyzer may be trained using big data, machine learning, and/or neuro networks, for example, to recognized the objects, the places, the actors, the actions, the moods, the themes, etc. of the streaming video to extract necessary metadata. The video analyzer 610 may generate supplemental data and send the supplemental data to the packager 620. The video analyzer 610 may reference and/or index the supplemental data to a content timing parameter. A content timing parameter may be based on a start time, a scene time marker, and/or a timing index of the audio and visual (A/V) content.

A packager 620 may package a video file from a DRM 615 and supplemental data (e.g., timed metadata) from a video analyzer 610 into a content package. The packager 620 may also package other files into the content package. The packager 620 may also package a manifest 640 in the content package that may reference both the A/V content and the supplemental data. The packager 620 may send the content package comprising the A/V content and the supplemental data to an origin server 625 using a streaming technique (e.g., DASH, HLS, etc.). The origin server may receive the content package and/or redirect it to an appropriate content delivery network (CDN) 630.

A CDN 630 may provide a cache to allow for quick transfer of content (e.g., A/V segments) and/or data supplemental data (e.g., timed metadata). The CDN 630 may provide the A/V segments and the supplemental data to a player 635 during playback of the content using the player 635. The CDN 630 may perform other actions. The CDN may generate a manifest 640 that may reference both A/V content as well as supplemental data, for example, if a packager 620 did not. The CDN 630, moreover, may add uniform resource locators (URLs) to a manifest to aid in finding and/or retrieving A/V segments and/or time metadata.

A player 635 may receive data from a CDN 630. The data may comprise A/V segments, supplemental data (e.g., timed metadata), and/or a manifest that may reference the A/V segments and/or the supplemental data. The player 635 may send the A/V segments to a display device 645 for playback. The player 635 may analyze the supplemental data and/or determine effects and/or control sequences of lighting devices 650 and/or other devices 655 (e.g., haptic devices, olfactory devices, etc.).

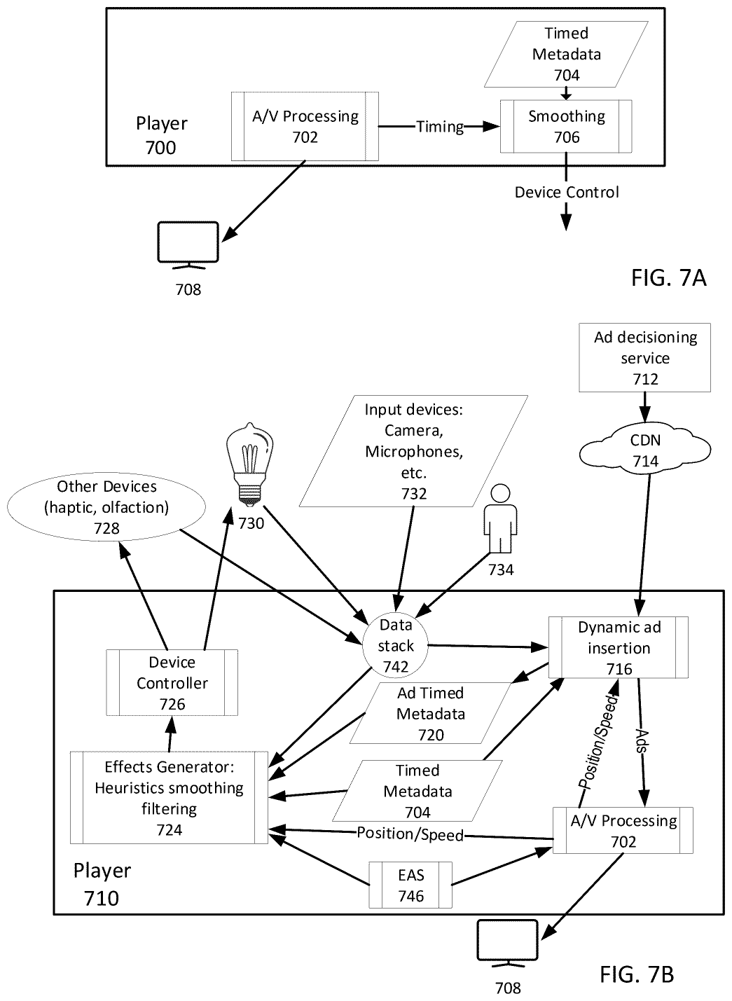

FIGS. 7A and 7B show examples of device controlling players 700 and 710. Device controlling players 700 and 710 may comprise a display device and may also comprise one or more input and/or output devices. FIG. 7A shows a device controlling player 700 comprising an A/V processing unit 702, a supplemental data (e.g., timed metadata) unit 704, and/or a smoothing unit 706. An A/V processing unit 702, for example, may provide switching and decoding of various content formats, volume control, distortion reduction, and/or audio processing. The A/V processing unit may also send A/V segments to a display device 708. The A/V processing unit may also send timing data to the smoothing unit 706. An A/V processing unit 702 may provide position and/or speed information determined by playing the A/V content, for example, so that the position and speed information is provided to other player components (e.g., a smoothing 706 component, a dynamic ad insertion 716 component, and/or an effects generator 724).

A supplemental data (e.g., timed metadata) unit 704 may receive and distribute supplemental data from a CDN to a smoothing unit 706. The smoothing unit 706 may determine the appropriate supplemental data to analyze, for example, based on the timing received from the A/V processing unit 702. The smoothing unit 706 may ensure instructions sent to ancillary devices may be timed to the appropriate A/V segment. The smoothing unit 706 may ensure abrupt changes in the output don't occur due to rapid changes on the supplemental data inputs. The smoothing unit 706 may also process upcoming supplemental data received from the supplemental data unit 704. The smoothing unit 706 may begin altering background lighting on a display device, for example, if the smoothing unit 706 determines that the next scene has a different mood and/or lighting scheme.

Also, or alternatively, a player may comprise additional components to further enhance ancillary device control. FIG. 7B shows a device controlling player 710 further comprising dynamic ad insertion, emergency alert system (EAS) insertion, as well as effects generation. An ad decisioning service 712 may send information on advertising content that may be combined with non advertising content. A CDN 714 may send details of content requested, known user details, and/or past user viewing profiles and/or purchasing profiles to the ad decisioning service 712. A CDN 714 may receive ad information to be played with content from the ad decisioning service 712, for example, based on a user and/or content profile.

A CDN may send (e.g., relay) ad information received from an ad decisioning service 712 to a device controlling player 710. A dynamic ad insertion system 716 may control the received ad information. The dynamic ad insertion system 716 may comprise receiving position and/or speed information from an A/V processing unit 702, from supplemental data (e.g., timed metadata) 704, and/or a data stack 742. The dynamic ad insertion 716 may send data concerning ad insertion to ad supplemental data. The data sent concerning ad supplemental data may include device control profiles to instruct a device controlling player 710 in controlling connected input and/or output devices. The device controlling player 710 may send a signal to background lighting to change the lighting colors to trademark colors of a company and/or colors associated with an ad that may be playing. The device controlling player 710 may send a signal to other devices. The player 710 may send commands for speakers to play a sound of soda being opened and/or poured into a glass. Dynamic ad insertion 716 may send ads to an A/V processing unit 702. The A/V processing unit 702 may insert the ads into the A/V segments, for example, at positions marked for ad insertion.

A dynamic ad insertion 716 component may combine a video position and/or timed video metadata with output devices available as well as any relevant and/or permissible data from the input devices to make a request to an ad decisioning service 712. The service may use this data to enhance an ad experience by targeting ads as well as providing additional timed ad metadata as provided with the A/V supplemental data (e.g., timed metadata). The dynamic ad insertion 716 component may inject ads into the A/V playback and provides the ad supplemental data to the effects generator so it can generate ad-specific effects.

Ad supplemental data (e.g., timed metadata) 720 may comprise effects that may control ancillary devices (e.g., lighting 730), for example, to accompany ads played on a display device 708. Ad supplemental data 720 may comprise color schemes for background lighting and/or color schemes for ambient lighting, Background lighting of a display device 708 may change to be the color scheme of the ad. The ad supplemental data 720 may send metadata data to an effects generator 724.

A player effects generator 724 component combines timing, speed, supplemental data (e.g., timed metadata), device information, and/or user preferences to determine devices to control and/or send control signals. The player effect generator 724 may employ deterministic and/or heuristic algorithms to optimize a user's experience. The player effects generator 724 may filter and/or smooth out lighting changes, for example, to prevent an active video scene from creating a flashing lights (e.g., a strobing) effect. The player effect generator 724 may also predictively send control signals ahead of actual video events, for example to draw the viewer's attention that something interesting is about to happen. The player effect generator 724 may send a general control signal. The general control signal may not be device specific. The general control signal, rather, may provide a generalized scheme (e.g., based on a mood and/or a theme) associated with AV content. The general control signal may also include an EAS indication.

A device controller 726 component may transform general control signals from a player effects generator 724 into control signals that may be specific to one or more output devices. A device controller 726 may raise light levels and/or brightness, stop playing background sounds, and/or send a message to a user's personal devices, for example, if the device controller 726 receives an EAS indication. A device controller 726 may change a display device's background lighting, for example, if the device controller receives 726 a general control signal indicating a change in background lighting. A device controller 726 may dim a display device's background lighting and/or ambient lighting as well as quieting the sound from an external speaker, for example, if the device controller 726 receives a general control signal indicating an intense scene in a movie thriller is about to occur. The device controller 726 may control one or more other devices comprising lighting 730 and other devices 728 (e.g., haptic devices, olfactory devices, background speakers, etc.).

Ancillary input devices 732 and/or output devices (e.g., lighting 730, haptic devices, olfactory devices, etc.) may provide data to a data stack 742. The data stack may also receive user input 734. The user input 734 may comprise preferences (e.g., user preferences) and/or a device layout. The data stack 742 may send data that may affect ad choices to a dynamic ad insertion 716 component. The data stack 742 may send information that may comprise a user being hungry, for example, if the device controlling player 710 receives data from a microphone comprising a user saying that they are hungry. The dynamic ad insertion 716 component may alter the next ad insertion to include delivery services and/or restaurants that deliver. The data stack 742 may send data that may affect effect generation to an effects generator 724. The data stack 742 may send data indicating that may raise ambient lighting levels, for example, if a user 734 indicates that an entertainment environment is too dark.

An Emergency Alert System (EAS) 746 component may interrupt events to control the video being played. An effects generator may use this same event to control devices that may alert the user through means outside of the display device 708. The device controlling player 710 may send an indication to a wearable device (e.g., a haptic device on a watch). The device controlling player 710 may raise ambient light levels, stop playback of the content, and/or provide a message on the display device 708 indicating an EAS message.

A player effects generator 724, device controller 726, and/or input summation components may be a part of a player, but may be implemented in a separate process and/or device from the player. A secondary device to a player may be used, for example, if the player is a legacy player without the necessary components to provide the enhanced experience described herein.

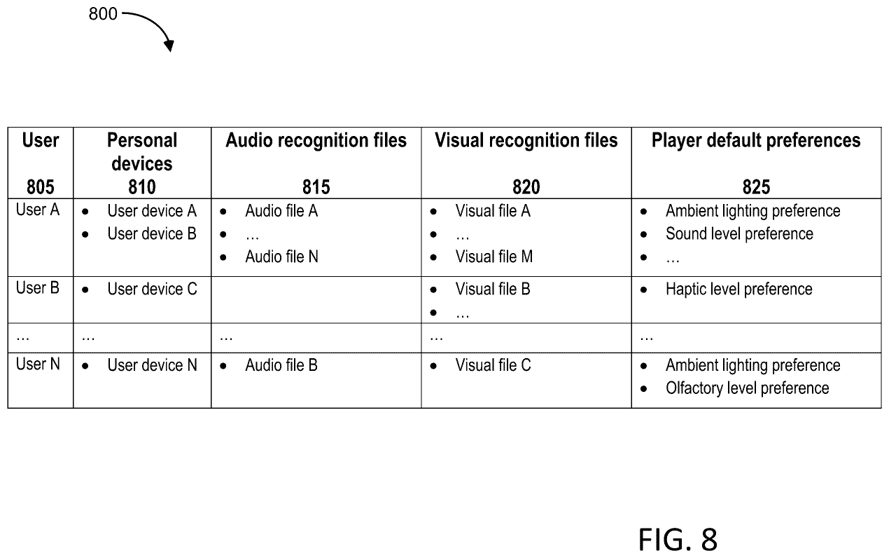

FIG. 8 shows an example of a user profile data file 800. A user profile data file 800 may comprise a user name 805, personal devices 810 that may be associated with the user 805, audio recognition files 815 and/or visual recognition files 820 that may identify the user, and/or the user's player default preferences 825. The user name 805 may be the actual name of the user, a name the user may use to login, and/or a label a player and/or server may reference the user by (e.g., User A, User B, etc.), to name a few non-limiting examples.

Personal devices 810 of a user may comprise phones, tablets, wearables, computers, etc. The personal devices of a user 810 may serve as additional input and/or output devices of a player. The personal devices may communicate with a player wirelessly. A user may have one or more personal devices that may connect with a player. A player may use audio data collected by a personal device of a user, for example, to suggest potential ads to be played on the player. A player may use audio data collected by a personal device of user to anticipate the user moving seats and/or leaving an entertainment area. A player may use accelerometer data to anticipate a user leaving their seat. A player may turn on lighting that may direct a user to an exit, for example, if the user device sends audio data of the user mentioning having to use a restroom and accelerometer data indicating movement to the player.

Audio recognition 815 and/or video recognition files 820 may be used to recognize a user. A player may compare received audio data to audio recognition files 815, for example, to determine if a user 805 is in the entertainment environment and may be watching content. Similarly, the player may compare received video and/or image data to video recognition files 820, for example, to determine if the user 805 is in the entertainment environment and may be watching content.

Player default preferences 825 may comprise settings of a player that a user 805 prefers. A user 805 may prefer brighter ambient lighting, for example, if the user has difficulty navigating low light situations and/or if the user is a parent and their child is a afraid of the dark. A user 805 may prefer a higher default volume level, for example, if the user 805 had difficulty hearing. A user 805 may prefer a lower default volume, for example, if the user 805 is sensitive to loud noises. A user 805 may prefer to have conversations in content to be at a higher volume, for example, if the user 805 has difficulty differentiating conversations from background noises. A user 805 may prefer particular olfactory sensations. The player may instruct an olfactory device to produce a scent of a flower field, for example, if the user 805 prefers the smell of flowers. A user 805 may prefer haptic sensations to be disabled and a player may disable all haptic devices in a seat of the user 805, for example, if the player determines that the user is in the entertainment environment and sitting in a particular seat.

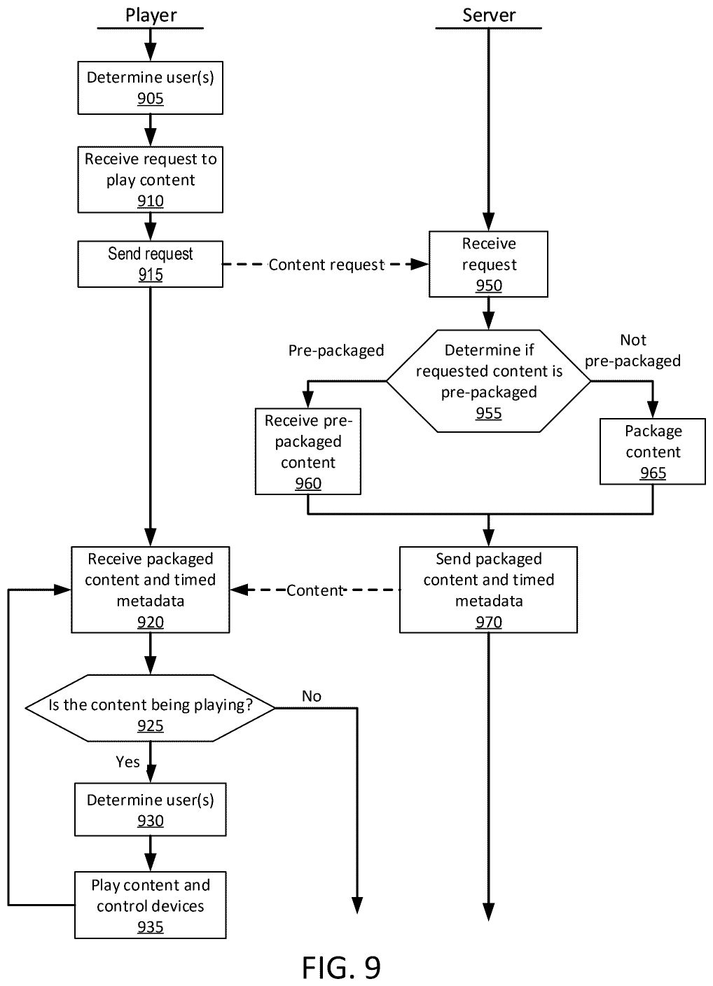

FIG. 9 shows an example method of a device controlling player receiving a packaged content and supplemental data file. Specifically, FIG. 9 shows an example flowchart depicting an example method of a device controlling player (e.g., device controlling player 700 or 710) receiving a packaged content and supplemental data (e.g., timed metadata) file and playing the content. A player may first determine, for example, if a user may is in an entertainment environment at step 905. The player may determine that the user may be in the entertainment environment, for example, based on receiving audio data from a microphone or video and/or image data from a camera. Also, or alternatively, the player may determine a user may be in the entertainment area based on a user's personal device connecting to the player and/or a communication network the player may be connected to.

At step 910 a player may receive a request to play content from a user. The user may use a remote enabled solely for the player to send the request to the player. The user may use a personal device (e.g., a phone, a tablet, a computer, a wearable device, etc.) to send the request to the player. A user may simply ask the player to play content, for example, if the player may be configured to receive input from a microphone. A player may be configured to receive hand gestures and use input from a camera.

At step 915 a player may send a request for content to a server (e.g., a package determination server). The server (e.g., the package determination server) may receive the request for content at step 950. A package determination server may be part of a prepackage content server 122 as described herein.

At step 955, a server (e.g., a package determination server) may determine, for example, if requested content is pre-packaged. Popular content may be pre-packaged, for example, for quicker retrieval. Content that may have been packaged previously may be saved in a pre-packaged state, for example, if a package server data capacity is sufficient. A package server may determine content that may be retained on the package server. Inevitably, content will be requested that may not be pre-packaged. Less requested content may not be pre-packaged. An older film, for example, may not be pre-packaged. Less popular content, for example, may not be pre-packaged.

A server may receive prepackaged content at step 960, for example, if at step 955 it is determined that requested content is pre-packaged. Content from prepackaged content server 122 may provide the prepackaged content. Alternatively, a server may package the requested content (e.g., using the method described herein in FIG. 4), for example, if at step 955 it is determined that the requested content is not pre-packaged. The packaging server may be a part of prepackaged content server 122. The packaging server may package supplemental data (e.g., timed metadata) and A/V data as described herein in FIG. 5. Packaged content may comprise the supplemental data and A/V data as well as additional data (e.g., a manifest as described herein in FIG. 5). At step 970, the packaged content may be sent to a player that requested the content. A CDN may deliver the packaged content, for example, to the player that requested the content as described herein in FIG. 4.

At step 920, a player may receive packaged content from a server. The packaged content may comprise the requested content as well as supplemental data (e.g., timed metadata). The player may begin playing the requested content upon receipt of the packaged content. The player may control devices and/or monitor users that may enter an entertainment environment and/or that may leave the entertainment environment while the content is being played. The player may adjust parameters based on users entering and/or leaving the entertainment environment.

At step 925, a player may determine, for example, if requested content is continuing to be played. A player may determine if content is being played, and proceed to step 930, for example, based on the content continuing to be played, or, alternatively, based on one or more users still being in the player's entertainment environment. Otherwise, the player may determine content playback should be stopped or paused, for example, if all users have left the entertainment environment or no users remain in the entertainment environment after a given period of time that may be set in the player's settings. A time period a player may continue to play content may be 5 minutes by default, for example, but a user may adjust that default value in a settings environment.

At step 930, a player may determine which users may be consuming content. The player may determine if a user moves. The player may change haptic outputs, for example, based on recognizing a user leaves and/or the user changes seats. The player may use user information to determine if ambient lighting brightness may need to be increased, for example, based on a user moving within, leaving, and/or entering an entertainment environment.

At step 935, a player may control devices and play the content. The player may control the devices based on time metadata received at step 920 and/or data received from input devices. A player may control background and/or ambient lighting, for example, based on metadata. The player may change the background lighting of a display device, for example, if the color scheme contained in the supplemental data (e.g., timed metadata) changes. The player may raise ambient light levels, for example, if users are moving around within the entertainment environment. A player may increase ambient lighting brightness around a particular user, for example, if the player determines that the particular user requires additional lighting. The player may continue to receive packaged content and supplemental data at step 920, for example, if the player continues to determine that content is continuing to be played at step 925.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

We claim:

1. A method, comprising:
receiving, by a device, a portion of a video file at a time earlier than encryption;
generating supplemental data associated with the portion of the video file; and
creating a packaged content file, wherein the packaged content file comprises one or more portions of the video file and supplemental data associated with the one or more portions of the video file.

2. The method of claim 1, further comprising sending the supplemental data associated with the video file to a second device.

3. The method of claim 1, wherein the packaged content file further comprises a manifest, wherein the manifest references both the video file and the supplemental data.

4. The method of claim 1, wherein the supplemental data comprises a time range and at least one of:
a color palette,
a mood,
one or more theme characterizations, and
an advertiser palette.

5. The method of claim 1, wherein the video file received at a time earlier than encryption is raw video or encoded video.

6. The method of claim 1, wherein the packaged content file further comprises advertising supplemental data.

7. The method of claim 1, wherein generating the supplemental data comprises:
analyzing the video file;
determining a time position of the video file; and
determining supplemental data associated with both the video file and the time position of the video file comprising one or more of:
keyword(s),
mood, and
color palate.

8. A method, comprising:
receiving, by a first device, a request for content;
analyzing the content, at an earlier time than encryption of the content, to generate supplemental data associated with the content; and
sending, to a second device, the content and the supplemental data associated with the content.

9. The method of claim 8, wherein the supplemental data comprises a time marker of the content and at least one of:
a content label associated with the time marker and the content;
a content description associated with the time marker and the content;
content keyword(s) associated with the time marker and the content;
a color analysis associated with the time marker and the content; and
content mood(s) associated with the time marker and the content.

10. The method of claim 8, wherein the content and the supplemental data are sent in a packaged content file;
further comprising creating a manifest, wherein the manifest collocates in time the supplemental data and the content; and
wherein the packaged content file further comprises the manifest.

11. The method of claim 8, further comprising:
receiving advertising insertion data, wherein the advertising insertion data comprises advertising video and advertising supplemental data;
inserting the advertising insertion data into a packaged content file; and
sending the packaged content file to the second device.

12. The method of claim 8, wherein the content is raw video or encoded video.

13. The method of claim 8, wherein analyzing the content comprises determining a time marker and determining one or more of:
one or more keywords,
a mood,
a place theme,
a character theme, and
color analysis.

14. The method of claim 8, further comprising:
receiving emergency alert system (EAS) data;
generating EAS supplemental data based on the EAS data; and
inserting the EAS data and the EAS supplemental data into the packaged content file.

15. The method of claim 8, wherein the sending is via one of hypertext transfer protocol (HTTP) live streaming (HLS) or dynamic adaptive streaming over HTTP (DASH).

16. A method, comprising:
receiving, by a first device, a video file and supplemental data associated with the video file, wherein encryption of the video file is subsequent to the generation of the supplemental data;
generating a package file comprising the video file and the supplemental data; and
sending the package file to a second device.

17. The method of claim 16, further comprising creating a manifest that references the video file and the supplemental data; and wherein the packaged file further comprises the manifest.

18. The method of claim 16, wherein the sending is via one of hypertext transfer protocol (HTTP) live streaming (HLS) or dynamic adaptive streaming over HTTP (DASH).

19. The method of claim 16, wherein the first device is a packager and the second device is an origin server, a content delivery network (CDN), or a video player.

20. The method of claim 16, further comprising:
receiving emergency alert system (EAS) data;
generating effects based on the EAS data; and
causing one or more of the one or more output devices to change states based on the generated effects based on the EAS data.
